(19) United States
(12) Patent Application Publication
(10) Pub. No.: US 2013/0109206 A1
(43) Pub. Date: May 2, 2013

(54) USB DEVICE AND METHOD OF MOVING USB CONNECTOR

(71) Applicants: Ryohei YAMAGUCHI, Fujisawa-shi (JP); Hide MABUCHI, Kamakura-shi (JP)

(72) Inventors: Ryohei YAMAGUCHI, Fujisawa-shi (JP); Hide MABUCHI, Kamakura-shi (JP)

(73) Assignee: Kabushiki Kaisha Toshiba, Minato-ku (JP)

(21) Appl. No.: 13/425,847

(22) Filed: Mar. 21, 2012

(30) Foreign Application Priority Data
Oct. 26, 2011 (JP) 2011-235190

(51) Int. Cl. H01R 13/44

(52) U.S. Cl. 439/131

(57) ABSTRACT

A USB device has a USB connector, a first housing comprising an opening through which the USB connector can be moved outward and inward, a second housing configured to be coupled to the first housing so that whether or not to cover the opening can be freely changed, and a movement controller configured to perform control for moving the USB connector outward and inward through the opening, in synchronization with whether or not the second housing covers the opening. The movement controller comprises a biasing force applying unit configured to apply a first biasing force in a direction in which the USB connector is accommodated in the first housing and to apply a second biasing force in a direction in which the second housing covers the opening, when the USB connector is pushed out from the opening.

### CROSS REFERENCE TO RELATED APPLICATIONS

This application is based upon and claims the benefit of priority from the prior Japanese Patent Application No. 2011-235190, filed on Oct. 26, 2011, the entire contents of which are incorporated herein by reference.

### FIELD

Embodiments of the present invention relate to a USB device having a USB connector of a general-purpose size.

### BACKGROUND

A USB connector is provided to various digital appliances such as PC, TV, and optical disk recorder. Various USB devices such as a USB memory can be connected to the USB connector, which makes it possible to transmit information easily. Further, the functions of the USB device can be expanded simply by incorporating additional functions for wireless communication etc. thereinto.

A portable stick-type USB device generally has a removable cap for covering the USB connector to protect the USB connector from shock, static electricity, dust, rust, etc.

However, there is a fear of losing the cap since it must be removed when using the USB connector. It is possible to connect the cap and the main body of the USB device with a strap etc., but the cap with the strap frequently becomes an obstacle to the operation using the USB connector.

Accordingly, there has been proposed a USB device having a cap rotatably fixed to the USB device so that there is no need to remove the cap when using the USB connector.

However, in the rotary cap technique, the operation is annoying since the cap must be rotated both when using and not using the USB connector. Further, sufficient user-friendliness is not provided since there is a case where a user cannot move the cap with one hand.

### BRIEF DESCRIPTION OF THE DRAWINGS

Each of FIGS. 1(A) to 1(C) is a diagram showing a USB device 1 according to a first embodiment of the present invention.

FIG. 2 is a perspective diagram showing an example of a supporter 16.

Each of FIGS. 3(A) and 3(B) is a sectional view of a USB device 1a according to a second embodiment.

Each of FIGS. 4(A) and 4(B) is a sectional view of a USB device 1b according to a third embodiment.

Each of FIGS. 5(A) and 5(B) is a sectional view of a USB device 1c according to a fourth embodiment.

### DETAILED DESCRIPTION

A USB device according to one embodiment has a USB connector, a first housing comprising an opening through which the USB connector can be moved outward and inward, a second housing configured to be coupled to the first housing so that whether or not to cover the opening can be freely changed, and a movement controller configured to perform control for moving the USB connector outward and inward through the opening, in synchronization with whether or not the second housing covers the opening. The movement controller comprises a biasing force applying unit configured to apply a first biasing force in a direction in which the USB connector is accommodated in the first housing and to apply a second biasing force in a direction in which the second housing covers the opening, when the USB connector is pushed out from the opening.

Embodiments will now be explained with reference to the accompanying drawings.

FIG. 1 is a diagram showing a USB device 1 according to a first embodiment of the present invention. The USB device 1 of FIG. 1 is typically a USB memory having a flash memory, but it may have a function other than a storage function. The present embodiment can be applied to the USB device 1 regardless of its functions, as long as the USB device 1 has a general-purpose USB connector.

FIG. 1(A) is a sectional view of a USB connector 2 and a wiring substrate 3 connected to the USB connector 2, each being included in the USB device 1. Each of FIGS. 1(B) and 1(C) is a sectional view of the USB device 1 according to the first embodiment. Each of them is a sectional view along the longitudinal direction of the USB device 1 around the center in the lateral direction thereof.

As shown in these drawings, the USB device 1 according to the present embodiment has the USB connector 2, the wiring substrate 3 connected to the USB connector 2, a first housing 4 having an opening 4a through which the USB connector 2 can be moved outward and inward, a second housing 5 coupled to the first housing 4 so that whether or not to cover the opening 4a can be freely changed, and a movement controller 6 performing control for moving the USB connector 2 outward and inward through the opening 4a, in synchronization with whether or not to cover the opening 4a by the second housing 5.

The USB connector 2 has a general-purpose size in order to be connected to a general-purpose USB terminal included in a PC etc. as standard equipment. The wiring substrate 3 has a semiconductor memory (such as flash memory, DRAM, and SRAM) for storing various types of data transmitted and received through the USB connector 2, and a controller for controlling transmitting and receiving the data, for example.

The shape of the USB device 1 in a normal state is as shown in FIG. 1(B), in which the back-end part of the second housing 5 (on the right side in the drawing) is raised from the first housing 4. The opening 4a is arranged at the fore-end of the first housing 4 (on the left side in the drawing), and is covered by the second housing 5 when the USB connector 2 is not used. Hereinafter, the state where the USB connector 2 is not used is referred to as a normal state.

In the USB device 1 according to the present embodiment, a user pushes the raised part of the second housing 5 on the back-end side by his/her finger when connecting the USB connector 2 to a USB terminal of another device. Accordingly, as shown in FIG. 1(C), the back-end part of the second housing 5 is moved downward and the fore-end part of the second housing 5 is raised upward, by which the opening 4a of the first housing 4 is exposed and the USB connector 2 is pushed out from the opening 4a toward the left side in the drawing. In this way, the USB connector 2 can be connected to a USB terminal of another device.

The above movement of the second housing 5 and the USB connector 2 is realized by the mechanism of the movement controller 6.

The movement controller 6 has a biasing force applying unit 7 for applying a first biasing force in a direction in which the USB connector 2 is accommodated in the first housing 4 and applying a second biasing force in a direction in which the second housing 5 covers the opening 4a, when the USB connector 2 is pushed out from the opening 4a.

When the user connects the USB connector 2 to another USB device by pushing the back-end part of the second housing 5 to push the USB connector 2 out from the opening 4a, the biasing force applying unit 7 accumulates the first and the second biasing forces. When the user removes the USB connector 2 from the another USB device and stops pushing the second housing 5, the biasing force applying unit 7 utilizes the accumulated first and second biasing forces to accommodate the USB connector 2 in the first housing 4 and to cover the opening 4a by the second housing 5.

More concretely, the biasing force applying unit 7 has a first arm 11 for moving the USB connector 2 outward and inward through the opening 4a, a second arm 12 for moving the second housing 5 while freely rotating with being connected to the first arm 11, and a biasing unit 13 for applying the first biasing force to the first arm 11 and applying the second biasing force to the second arm 12. The biasing unit 13 stretches when the user pushes the back-end part of the second housing, and compresses and returns to its natural state when the user stops pushing. One end of the biasing unit 13 is connected to the connection between the first arm 11 and the second arm 12, and the other end of the biasing unit 13 is connected to the first housing 4. The first arm 11 is joined to an arm connector 14 fixed to an edge of the wiring substrate 3. The second arm 12 is joined to the second housing 5.

When the user pushes the back-end part of the second housing 5, the biasing unit 13 stretches, and the first arm 11 pushes the arm connector 14 toward the opening 4a (toward the left side in the horizontal direction), while the second arm 12 moves the back-end part of the second housing 5 downward and raises the fore-end part thereof upward. When the user stops pushing, the biasing unit 13 returns to its natural state, and the first arm 11 pulls the arm connector 14 to the right side in the horizontal direction, while the second arm 12 raises the back-end part of the second housing 5 upward and moves the fore-end part downward.

As stated above, the first arm 11 moves the arm connector 14 to right and left in the horizontal direction, and the second arm 12 moves the fore-end part and back-end part of the second housing 5 in opposite directions.

The arm connector 14 and the USB connector 2 are arranged at opposing two edges of the wiring substrate 3. Therefore, the first arm 11 integrally moves the USB connector 2, the wiring substrate 3, and the arm connector 14 to right and left in the horizontal direction.

As stated above, the second arm 12 moves the fore-end part and back-end part of the second housing 5 in opposite directions. Accordingly, when the back-end part of the second housing 5 is pushed, the second arm 12 raises the fore-end part upward to expose the opening 4a of the first housing 4, while when the push is stopped, the second arm 12 moves the fore-end part of the second housing 5 downward to cover the opening 4a of the first housing 4 by the second housing 5.

The second housing 5 can be rotated around a rotating shaft 20 fixed to the first housing 4 within a predetermined angular range. When the second housing 5 is rotated around the rotating shaft 20 in the clockwise direction, the opening 4a is exposed and the USB connector 2 is pushed out from the opening 4a.

As shown in FIG. 1(B), a stopper 15 is fixed to the upper face of the second housing. When connecting the USB connector 2 to a USB terminal of another device, the stopper 15 prevents the USB connector 2 from being pushed back toward the opening 4a due to the counteraction caused by pushing the USB connector 2 into the USB terminal. More concretely, the arm connector 14 comes into contact with the stopper 15 while pushing out the USB connector 2 from the opening 4a. Since the arm connector 14 moving integrally with the USB connector 2 comes into contact with the stopper 15, even when a force pushing back the USB connector 2 toward the opening 4a is exerted, the USB connector 2 pushed back does not reach the inside of the opening 4a. Accordingly, the USB connector 2 can be simply and surely connected to a USB terminal of an external device.

When connecting the USB connector 2 of the USB device 1 to a USB terminal of another device, the user has to keep pushing the back-end part of the second housing 5 until the connection is completed. Once the USB connector 2 is connected to the external device, the position of the first arm 11 does not change even if the second housing 5 is not pushed by the user, since the USB connector 2 is firmly fitted into the USB terminal of the another device. The fact that the position of the first arm 11 does not change means that the position of the second arm 12 also does not change, while the biasing unit 13 is kept stretching.

After that, when the user removes the USB connector 2 from the external device, if the user stops pushing the second housing 5, the biasing unit 13 returns to its natural state while moving the first arm 11 to the right side in the horizontal direction by the first biasing force and moving the second arm 12 upward by the second biasing force. Accordingly, the USB connector 2 moves to the inside of the opening 4a of the first housing 4, and the second housing 5 covers the opening 4a of the first housing 4, thereby the normal state as shown in FIG. 1(B) being restored.

As stated above, the USB connector 2, the wiring substrate 3, and the arm connector 14 are integrally moved to right and left in the horizontal direction corresponding to the movement of the first arm 11. It is desirable that a supporter 16 for supporting the wiring substrate 3 is arranged to prevent backlash caused when these components are being moved.

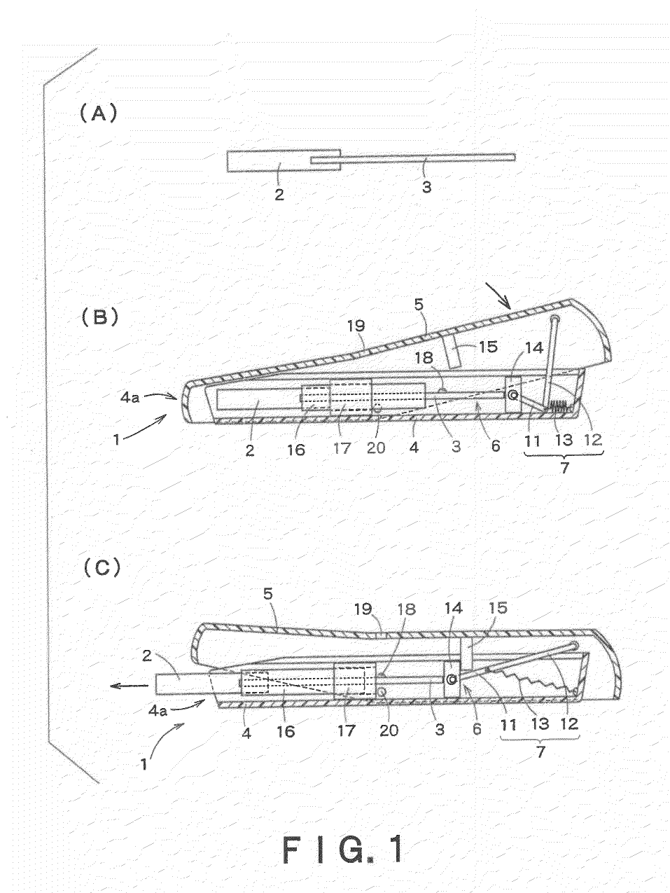

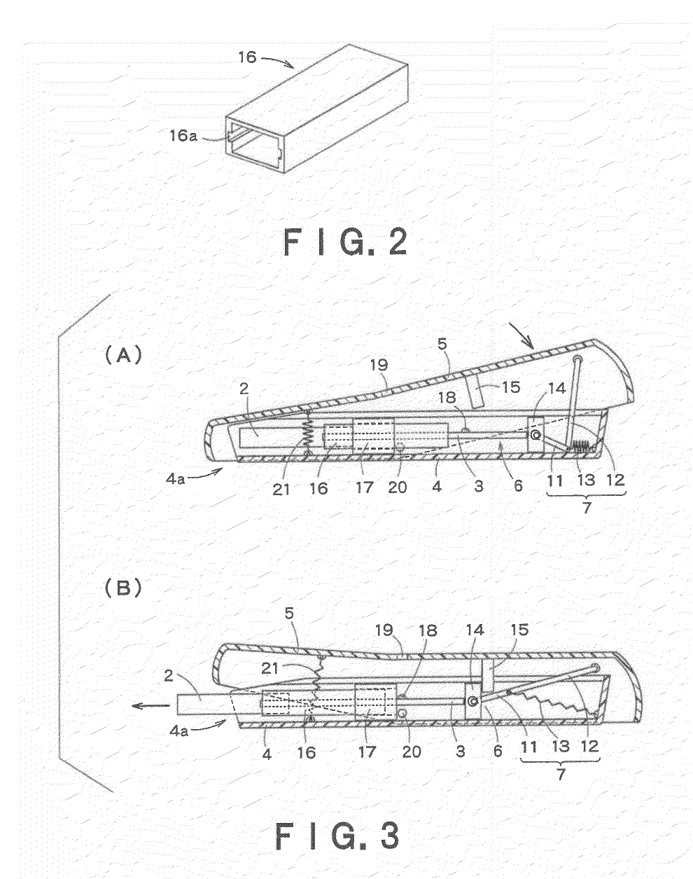

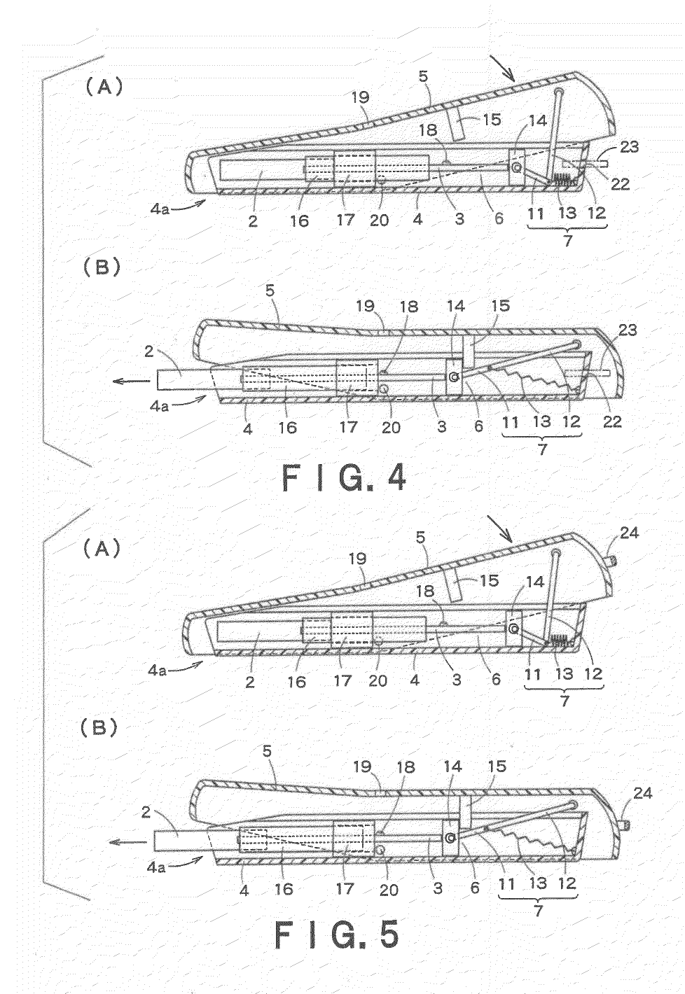

FIG. 2 is a perspective diagram showing an example of the supporter 16. The supporter 16 of FIG. 2 is a tubular member having a rectangular cross section. The supporter 16 has grooves 16a formed on its inner walls to support and fix the wiring substrate 3. The wiring substrate 3 is fixed with its opposing two edges inserted in the grooves 16a.

The length of the supporter 16 may be shorter than the length of the wiring substrate 3. This is because no backlash is caused when the wiring substrate 3 is being moved, by firmly supporting and fixing a part of the opposing two edges of the wiring substrate 3.

Since the wiring substrate 3 is fixed to the supporter 16, the USB connector 2, the wiring substrate 3, the supporter 16, and the arm connector 14 are integrally moved. If the width and height of the supporter 16 are nearly corresponding to the width and height of the first housing 4, no backlash is caused when the supporter 16 is being moved. However, when regulating the moving direction of the supporter 16 more correctly, a guide 17 for regulating the moving direction of the supporter 16 may be provided to the first housing 4, as shown in FIG. 1(B). The guide 17 fixed to the first housing 4 is a tubular member having a rectangular cross section. The supporter 16 can pass through the inside of the guide 17. By setting the width and height of the inner walls of the guide 17 to nearly the same as the width and height of the supporter 16, the supporter 16 can be moved along the inner walls of the guide 17 in an accurate direction. Note that the length of the guide 17 may be shorter than the length of the supporter 16.

When the USB device 1 has a storage function, it is desirable that whether or not the USB device 1 is being accessed can be observed from the outside. Accordingly, in the present embodiment, a light-emitting element 18 lighting in an access state is arranged on the wiring substrate 3, and a light transmissive part 19 is arranged in the second housing 5 to be located directly above the light-emitting element 18 when the USB connector 2 is pushed out from the opening 4a. The light transmissive part 19 may be a through-hole having a small diameter, or the top surface of the through-hole may be covered by a transparent or semitransparent lid, or the housing thickness for the light transmissive part 19 may be reduced so that light can be transmitted therethrough. Note that the light transmissive part 19 is not necessarily essential, and thus may be omitted. When omitting the light transmissive part 19, there is no need to arrange the light-emitting element 18 on the wiring substrate 3.

As stated above, in the USB device 1 according to the first embodiment, the USB connector 2 is accommodated in the first housing 4 when not being used. When the user pushes the back-end part of the second housing 5, the opening 4a of the first housing 4 is exposed and the USB connector 2 is pushed out therethrough, while when the user stops pushing, the USB connector 2 is automatically pulled back to the inside of the opening 4a and the opening 4a is covered by the second housing 5. That is, in the present embodiment, the user can move the USB connector 2 outward and inward by opening and closing the opening 4a with one hand, which makes it possible to easily and surely protect the USB connector 2 from shock, static electricity, dust, rust, etc.

### Second Embodiment

In the USB device 1 according to the first embodiment, the biasing force of the biasing unit 13 arranged at its back-end part is utilized to perform control for opening and closing the opening 4a of the first housing 4 and for moving the USB connector 2 in the horizontal direction. The fore-end part of the second housing 5 is moved upward and downward by moving the second arm 12 upward and downward. Since the second arm 12 is apart from the fore-end part of the second housing 5, there may be a case where the fore-end part is not moved upward and downward, against the user's intention.

Accordingly, an auxiliary biasing unit 13 may be additionally arranged between the fore-end part of the second housing 5 and the fore-end part of the first housing 4 in order to move the fore-end part of the second housing 5 upward and downward utilizing the biasing force of the auxiliary biasing unit 13.

FIG. 3 is a sectional view of a USB device is according to a second embodiment. In FIG. 3, the same components as those in FIG. 1 are given the same symbols, and differences therebetween will be mainly explained.

The USB device is of FIG. 3 is different from the USB device 1 of FIG. 1 in having an auxiliary biasing unit 21 arranged between the fore-end part of the second housing 5 and the fore-end part of the first housing 4. The auxiliary biasing unit 21 stretches and compresses in synchronization with the biasing unit 13. For example, when the user pushes the back-end part of the second housing 5, the biasing unit 13 stretches, and the second arm 12 moves the back-end part of the second housing 5 downward while raising the fore-end part upward. Correspondingly, the auxiliary biasing unit 21 stretches.

In this state, when the user stops pushing the back-end part of the second housing 5, both of the biasing unit 13 and the auxiliary biasing unit 21 compress to return to their natural state. Based on the biasing force of the biasing unit 13, the first arm 11 moves the USB connector 2 toward the inside of the opening 4a, while the second arm 12 raises the back-end part of the second housing 5 upward. Further, based on the biasing force of the auxiliary biasing unit 21, the fore-end part of the second housing 5 is moved downward to cover the opening 4a.

As stated above, in the second embodiment, the auxiliary biasing unit 21 is arranged between the fore-end part of the second housing 5 and the fore-end part of the first housing 4, which makes it possible to easily move the fore-end part of the second housing 5 upward and downward, and to open and close the opening 4a of the first housing 4 correctly.

### Third Embodiment

The USB device 1 having a storage function has a flash memory therein, which makes it possible to easily move a great deal of data by connecting the USB device 1 to a USB terminal of a PC etc. On the other hand, a camera or a cellular phones generally has a memory card slot instead of a USB terminal. Generally, data of a memory card inserted into the memory card slot is loaded into a PC through a reader/writer. The size of the reader/writer has been made smaller and smaller, and a stick-type reader/writer having the USB connector 2 is now widely used. The stick-type reader/writer has a narrow width and is suitable for reading/writing data using an extremely small-sized memory card (such as a microSD card).

The USB device 1 according to a third embodiment has a memory card slot into which such an extremely small-sized memory card can be inserted.

FIG. 4 is a sectional view of a USB device 1b according to the third embodiment. The USB device 1b of FIG. 4 is different from the USB device 1 of FIG. 1 in having a memory card slot 22 arranged at an end face of the back-end part of the first housing 4.

Since the USB device 1b of FIG. 4 is a stick type having a narrow width, it is assumed that a memory card which can be inserted into the memory card slot 22 is an extremely small-sized one (such as a microSD card).

When writing and reading data into and from the memory card using the USB device lb of FIG. 4, following steps are conducted.

As shown in FIG. 4(A), first, the user inserts the memory card into the memory card slot 22 with the USB connector 2 being accommodated in the first housing 4, and then pushes the back-end part of the second housing 5. At this time, as shown in FIG. 4(B), the second housing 5 covers almost entirely the first housing 4. Since the end face of the back-end part of the second housing 5 is located far behind the end face of the back-end part of the first housing 4, the end face of the back-end part of the second housing 5 does not collide with the memory card partially sticking out from the end face of the back-end part of the first housing 4. If there is a possibility of collision, the back-end part of the second housing 5 should be somewhat lengthened previously, depending on how long the memory card sticks out.

As stated above, in the third embodiment, it is possible to push the second housing 5 with the memory card inserted into the memory card slot 22. Accordingly, the above structure can be applied to the USB device lb which can be used as a memory card reader/writer.

### Fourth Embodiment

A fourth embodiment is provided to attach a strap.

FIG. 5 is a sectional view of the USB device 1 according to the fourth embodiment. The USB device 1c shown in FIGS. 5(A) and 5(B) is characterized in that a strap attachment 24 is arranged at an end face of the back-end part of the second housing 5, compared to the USB device 1 shown in FIGS. 1(A) and 1(B).

The strap attachment 24 has a through-hole formed to lead a strap therethrough. Since a strap can be simply attached by arranging such a strap attachment 24, the USB device 1c can be used with being dangled from the user's neck, which improves convenience. Further, by peculiarizing the shape and color of the USB device 1c and strap, the USB device 1c can be provided with excellent design.

### Other Modification Examples

Each of the USB devices 1, 1a, 1b, and 1c shown in FIGS. 1 to 5 (hereinafter, collectively referred to as USB device 1), is merely an embodiment. The USB device 1 having the above structure may have various functions. For example, a fingerprint identification function may be provided to identify fingerprints when the user touches a predetermined area of the USB device 1 with his/her finger pad.

Further, an antenna for wireless communication and an antenna for One Seg or digital terrestrial TV may be incorporated into the USB device 1 to realize wireless communication and TV viewing using the USB device 1. In this case, a communication device and a tuner may be further incorporated into the USB device 1, but only an antenna may be incorporated into the USB device 1 while arranging the communication device and tuner in another device to be connected thereto through the USB connector 2. There is no particular restriction on the communication method of the communication device, and various communication methods such as wireless LAN and Bluetooth (registered trademark) can be applied.

the USB device 1 may be based on USB Composite Device Class or USB Storage (Mass Storage) Device Class under USB-IF standards, and may not be based on the standards. The present embodiment can be applied to the USB device 1 regardless of its functions, as long as the USB device 1 has the USB connector 2 of a general-purpose size.

Further, an imaging device and a microphone may be incorporated into the USB device 1 to have a function of loading video and sound.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A USB device comprising:
a USB connector;
a first housing comprising an opening through which the USB connector can be moved outward and inward;
a second housing configured to be coupled to the first housing so that whether or not to cover the opening can be freely changed; and
a movement controller configured to perform control for moving the USB connector outward and inward through the opening, in synchronization with whether or not the second housing covers the opening,
wherein the movement controller comprises a biasing force applying unit configured to apply a first biasing force in a direction in which the USB connector is accommodated in the first housing and to apply a second biasing force in a direction in which the second housing covers the opening, when the USB connector is pushed out from the opening.

2. The USB device of claim 1,
wherein when a predetermined part of the second housing is pushed, the movement controller moves the USB connector toward the opening so that the USB connector is pushed out from the opening, and moves the second housing so that the opening is not covered by the second housing.

3. The USB device of claim 1,
wherein the biasing force applying unit accumulates the first and second biasing forces while a predetermined part of the second housing is pushed and the USB connector pushed out from the opening is connected to another USB device, and utilizes the accumulated first and second biasing forces to accommodate the USB connector in the first housing and to cover the opening by the second housing, when the USB connector is disconnected from the another USB device and the pressure on the second housing is released.

4. The USB device of claim 1,
wherein the biasing force applying unit comprises:
a first arm configured to move the USB connector outward and inward through the opening;
a second arm configured to move the second housing while freely rotating with being connected to the first arm; and
a biasing unit configured to apply the first biasing force to the first arm, and apply the second biasing force to the second arm.

5. The USB device of claim 4, further comprising:
a wiring substrate configured to be joined to the USB connector; and
an arm connector configured to be connected to the first arm, and arranged at an edge of the wiring substrate on an opposite side from an edge joined to the USB connector,
wherein the USB connector, the wiring substrate, and the arm connector are integrally moved corresponding to the movement of the first arm, in order to move the USB connector outward and inward through the opening.

6. The USB device of claim 5, further comprising:
a supporter configured to support and fix the wiring substrate,
wherein the USB connector, the wiring substrate, the arm connector, and the supporter are integrally moved.

7. The USB device of claim 6, further comprising:
a guide configured to guide the movement of the supporter while being arranged to cover at least a part of the supporter.

8. The USB device of claim 5, further comprising:
a light-emitting element configured to be mounted on the wiring substrate,
wherein the first housing comprises a light transmissive window at a position where a light-emitting state of the light-emitting element can be observed from the outside when the USB connector is pushed out from the opening.

9. The USB device of claim 1, further comprising:
an auxiliary biasing unit configured to move at least the opening side of the second housing in synchronization with the movement of the USB connector.

10. The USB device of claim 9,
wherein one end of the auxiliary biasing unit is connected to a fore-end part of the second housing on the opening side, and the other end of the auxiliary biasing unit is connected to a fore-end part of the first housing on the opening side.

11. The USB device of claim 1, further comprising:
a memory card slot through which a memory card having a predetermined shape can be inserted and removed, the memory card slot being arranged at an end face of the first housing on an opposite side from the opening.

12. The USB device of claim 1, further comprising:
a strap attachment configured to be arranged at an end of the second housing on an opposite side from the opening side.

13. A method of moving a USB connector, comprising:
pushing a second housing coupled to a first housing having an opening through which the USB connector can be moved outward and inward, in order to pushing out the USB connector from the opening; and
applying a first biasing force in a direction in which the USB connector is accommodated in the first housing and applying a second biasing force in a direction in which the second housing covers the opening, when the USB connector is pushed out from the opening.

14. The moving method of claim 13,
wherein when a predetermined part of the second housing is pushed, the USB connector is moved toward the opening so that the USB connector is pushed out from the opening, and the second housing is moved so that the opening is not covered by the second housing.

15. The moving method of claim 13,
wherein the first and second biasing forces are accumulated while a predetermined part of the second housing is pushed and the USB connector pushed out from the opening is connected to another USB device, and the accumulated first and second biasing forces are utilized to accommodate the USB connector in the first housing and to cover the opening by the second housing, when the USB connector is disconnected from the another USB device and the pressure on the second housing is released.

16. The moving method of claim 13,
wherein the first biasing force is applied to a first arm for moving the USB connector outward and inward through the opening, and the second biasing force is applied to a second arm for moving the second housing while freely rotating with being connected to the first arm.

17. The moving method of claim 16,
wherein the USB connector, a wiring substrate joined to the USB connector, and an arm connector connected to the first arm and arranged at an edge of the wiring substrate on an opposite side from an edge joined to the USB connector are integrally moved corresponding to the movement of the first arm, in order to move the USB connector outward and inward through the opening.

18. The moving method of claim 17,
wherein the USB connector, the wiring substrate, the arm connector, and a supporter for supporting and fixing the wiring substrate are integrally moved.

19. The moving method of claim 18,
wherein the supporter moves along inner walls of a guide arranged to cover at least a part of the supporter.
